(19) United States
(12) Patent Application Publication
(10) Pub. No.: US 2024/0428368 A1
(43) Pub. Date: Dec. 26, 2024

(54) EFFICIENT CACHE USAGE IN AN IMAGE PROCESSING SYSTEM

(71) Applicant: QUALCOMM Incorporated, San Diego, CA (US)

(72) Inventors: Vinay Thomas, San Diego, CA (US); David Berrebi, Netanya (IL); Victor Pinto, Zichron Yaakov (IL); George Patsilaras, San Diego, CA (US); Roee Hardoon, Zichron Yaakov (IL); Shruti Krishnamurthy, San Diego, CA (US); Weiliang Liu, San Diego, CA (US); Lingfeng Li, San Jose, CA (US); Alain Artieri, Saint Martin D'Heres (FR); Abhilash Shivashankara Pillai, San Diego, CA (US)

(21) Appl. No.: 18/338,272

(22) Filed: Jun. 20, 2023

(51) Int. Cl. G06T 1/60; G06F 12/0891

(52) U.S. Cl. CPC G06T 1/60; G06F 12/0891

(57) ABSTRACT

This disclosure provides systems, methods, and devices for image signal processing that support efficient cache usage in an image processing system. In a first aspect, a method of image processing includes storing, by an image processor, a first portion of a first stripe of a first frame in a cache, the first portion of the first stripe overlapping a second portion of a second stripe of the first frame, reading, by the image processor, a third portion of the second stripe from a memory, reading, by the image processor, the first portion of the first stripe from the cache, and processing, by the image processor, the second stripe using the first portion of the first stripe and the third portion of the second stripe. Other aspects and features are also claimed and described.

### TECHNICAL FIELD

Aspects of the present disclosure relate generally to image processing, and more particularly, to enhanced image processing efficiency. Some features may enable and provide improved image processing, including efficient cache usage in an image processing system.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The amount of image data captured by an image sensor has increased through subsequent generations of image capture devices. The amount of information captured by an image sensor is related to a number of pixels in an image sensor of the image capture device, which may be measured as a number of megapixels indicating the number of millions of sensors in the image sensor. For example, a 12-megapixel image sensor has 12 million pixels. Higher megapixel values generally represent higher resolution images that are more desirable for viewing by the user.

The increasing amount of image data captured by the image capture device has some negative effects that accompany the increasing resolution obtained by the additional image data. Additional image data increases the amount of processing performed by the image capture device in determining image frames and videos from the image data, as well as in performing other operations related to the image data. For example, the image data may be processed through several processing blocks for enhancing the image before the image data is displayed to a user on a display or transmitted to a recipient in a message. Each of the processing blocks consumes additional power proportional to the amount of image data, or number of megapixels, in the image capture. The additional power consumption may shorten the operating time of an image capture device using battery power, such as a mobile phone.

Image data loaded from a memory of an image capture device for processing by one or more processing elements of the image capture device, such as by an image signal processor, may be stored in a cache for efficient access by the image signal processor. Cache space of an image signal processor may, however, be limited. With increasing amounts of image data being stored and processed, efficient usage of cache storage has become increasingly important. As one particular example, whole frames may be stored in a cache for processing by multiple cores of an image processor.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, an image frame may be divided into multiple vertical sections, referred to herein as stripes, for efficient processing. At least a portion of each stripe may overlap with adjacent stripes to preserve continuity in image processing. A section of a first stripe of a frame that overlaps a section of an adjacent second stripe of the frame may be loaded from memory for processing the stripe and stored in a cache. The overlapping section of the first stripe stored in the cache may then be read from the cache for processing the second stripe of the frame that includes the overlapping section. Thus, instead of reading the overlapping section of the stripe from memory multiple times for processing stripes that include the overlapping portion, the overlapping portion of the stripe may be read from memory a single time, stored in a cache, and read from the cache for processing of a subsequent stripe that includes the overlapping portion of the stripe. After the overlapping section has been read from the cache a final time for processing of a final stripe that includes the overlapping section, the overlapping section stored in the cache may be invalidated, such as forgotten, erased, and/or evicted from the cache. Cache usage efficiency may be further enhanced through invalidation of stripe data stored in the cache after a final read of the stripe data from the cache in other contexts. For example, in performing multi-pass processing using multiple resolutions of an image frame, metadata associated with a stripe of a first resolution of an image frame may be stored in a cache until all stripes of a second resolution of the image frame that depend on the metadata associated with the stripe of the first resolution of the image frame are processed. The metadata associated with the stripe of the first resolution stored in the cache may then be invalidated. Efficiency may be further enhanced through reordering of processing of stripes of different resolutions of a frame, such that all stripes of the second resolution of the frame that depend on metadata associated with the stripe of the first resolution of the frame are processed before processing of another stripe of the first resolution of the frame. As another example, processing using a reference frame, such as motion processing, may include storing a stripe of a reference frame in a cache for use in processing stripes of a current frame being processed using the stripe of the reference frame and invalidating the stripe of the reference frame in the cache based on a greatest motion vector between the reference frame and the current frame.

Efficient cache usage in an image processing system may include storage of overlapping sections of stripes of an image frame in a cache until such sections have been read for processing of a last stripe including the sections, at which point the sections of the stripes stored in the cache will be invalidated. Such storage may enhance cache usage efficiency by reducing a number of write operations to a cache and reducing an amount of cache space used for storage of image stripes. Furthermore, reading an overlapping section of a stripe for processing a second stripe including the overlapping section from the cache rather than from the memory may consume less power and may be performed in less time, reducing power usage and latency. Storage of metadata associated with stripes of a first resolution of an image frame only until processing of stripes of a second resolution of the image frame that depend the metadata is complete may also reduce cache usage, as metadata stored in the cache may be invalidated after a final read of the metadata from the cache. Furthermore, reordering of stripes of a second resolution of an image frame that depend on metadata associated with the stripe of the first resolution of the image frame to be processed sequentially following storage of the metadata in the cache may further reduce cache usage, as the metadata associated with the stripe of the first resolution of the image frame may be stored in the cache for a reduced period of time because stripes of the second resolution of the image frame that depend on the metadata will be prioritized for processing. Invalidating stripes of a reference frame stored in a cache based on a largest motion vector between the reference frame and a currently processed frame may further reduce cache usage, as such stripes may be invalidated after a final read of the stripes from the cache.

In one aspect of the disclosure, a method for image processing includes storing, by an image processor, a first portion of a first stripe of a first frame in a cache, the first portion of the first stripe overlapping a second portion of a second stripe of the first frame, reading, by the image processor, a third portion of the second stripe from a memory, reading, by the image processor, the first portion of the first stripe from the cache, and processing, by the image processor, the second stripe using the first portion of the first stripe and the third portion of the second stripe.

In an additional aspect of the disclosure, an apparatus includes at least one processor and a memory coupled to the at least one processor. The at least one processor is configured to perform operations including storing first portion of a first stripe of a first frame in a cache, the first portion of the first stripe overlapping a second portion of a second stripe of the first frame, reading a third portion of the second stripe from a memory, reading, by the image processor, the first portion of the first stripe from the cache, and processing, by the image processor, the second stripe using the first portion of the first stripe and the third portion of the second stripe.

In an additional aspect of the disclosure, an apparatus includes means for storing a first portion of a first stripe of a first frame in a cache, the first portion of the first stripe overlapping a second portion of a second stripe of the first frame, means for reading a third portion of the second stripe from a memory, means for reading the first portion of the first stripe from the cache, and means for processing the second stripe using the first portion of the first stripe and the third portion of the second stripe.

In an additional aspect of the disclosure, a non-transitory computer-readable medium stores instructions that, when executed by a processor, cause the processor to perform operations. The operations include storing a first portion of a first stripe of a first frame in a cache, the first portion of the first stripe overlapping a second portion of a second stripe of the first frame, reading a third portion of the second stripe from a memory, reading the first portion of the first stripe from the cache, and processing the second stripe using the first portion of the first stripe and the third portion of the second stripe.

In one aspect of the disclosure, a method for image processing includes storing, by an image processor in a cache, metadata associated with a first stripe of a first resolution of a first frame, processing, by the image processor, a plurality of stripes of a second resolution of the first frame using the metadata, and invalidating the metadata in the cache after processing the plurality of stripes.

In an additional aspect of the disclosure, an apparatus includes at least one processor and a memory coupled to the at least one processor. The at least one processor is configured to perform operations including storing, in a cache, metadata associated with a first stripe of a first resolution of a first frame, processing a plurality of stripes of a second resolution of the first frame using the metadata, and invalidating the metadata in the cache after processing the plurality of stripes.

In an additional aspect of the disclosure, an apparatus includes means for storing, in a cache, metadata associated with a first stripe of a first resolution of a first frame; means for processing a plurality of stripes of a second resolution of the first frame using the metadata, and means for invalidating the metadata in the cache after processing the plurality of stripes.

In an additional aspect of the disclosure, a non-transitory computer-readable medium stores instructions that, when executed by a processor, cause the processor to perform operations. The operations include storing, in a cache, metadata associated with a first stripe of a first resolution of a first frame, processing a plurality of stripes of a second resolution of the first frame using the metadata, and invalidating the metadata in the cache after processing the plurality of stripes.

In one aspect of the disclosure, a method for image processing includes storing, by an image processor in a cache, a first stripe of a first frame, determining, by the image processor, a value of a greatest motion vector associated with the first frame and a second frame, and invalidating, by the image processor, the first stripe of the first frame in the cache based on the determined value of the greatest motion vector.

In an additional aspect of the disclosure, an apparatus includes at least one processor and a memory coupled to the at least one processor. The at least one processor is configured to perform operations including storing, in a cache, a first stripe of a first frame, determining a value of a greatest motion vector associated with the first frame and a second frame, and invalidating the first stripe of the first frame in the cache based on the determined value of the greatest motion vector.

In an additional aspect of the disclosure, an apparatus includes means for storing, in a cache, a first stripe of a first frame, means for determining a value of a greatest motion vector associated with the first frame and a second frame, and means for invalidating the first stripe of the first frame in the cache based on the determined value of the greatest motion vector.

In an additional aspect of the disclosure, a non-transitory computer-readable medium stores instructions that, when executed by a processor, cause the processor to perform operations. The operations include storing, in a cache, a first stripe of a first frame, determining a value of a greatest motion vector associated with the first frame and a second frame, and invalidating the first stripe of the first frame in the cache based on the determined value of the greatest motion vector.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAS), panels or tablets, gaming devices, computing devices such as webcams, video surveillance cameras, or other devices with digital imaging or video capabilities.

The image processing techniques described herein may involve digital cameras having image sensor and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more images sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of the tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or deter mined by the application processor, such as through image processing techniques described in various embodiments herein, the output image frame may be displayed on a device display as a single still as part of a video sequence, saved to a storage device as a picture or a video sequence, transmitted over a network, and/or printed to and output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or cameral modules for further processing, such as for 3A parameter synchronization (e.g., automatic focus (AF), automatic white balance (AWB), and automatic exposure control (AEC), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of the disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For sample, the first image sensor may have a larger field of view (FOV) than the second image sensor, or the first image sensor may have different sensitivity or different dynamic than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnifications. Any of these or other configurations may be part of a lens cluster on a mobile device, such as where multiple image sensors and associated lenses are located in off et locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs). Bayer-filter sensors, infrared (IR) detectors, ultraviolet (UV) detectors, complimentary metal oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent is to those of ordinary skill in the art, reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, on or more of such features also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purpose of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementation are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffers, processor(s), interleaver, adders/summers, etc.). It is intended that innovations descried herein may be practiced in a wide variety of devices, chip-level components, systems, distributed arrangements, end-user devices, etc., of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2 shows a block diagram illustrating an example data flow path for image data processing in an image capture device according to one or more embodiments of the disclosure.

FIG. 3 shows a block diagram of example overlapping stripes of an image frame according to some embodiments of the disclosure.

FIG. 4 shows an example cache allocation command for writing of portions of stripes of an image frame from a memory to a cache according to some embodiments of the disclosure.

FIG. 5 shows a flow chart of an example method for processing image data with enhanced cache usage in storing overlapping sections of image frame stripes according to some embodiments of the disclosure.

FIG. 6 shows a block diagram of example processing dependencies between different stripes of different resolutions of an image frame according to some embodiments of the disclosure.

FIG. 7 shows a block diagram of example ordering of processing of different stripes of different resolutions of an image frame according to some embodiments of the disclosure.

FIG. 8 shows a flow chart of an example method for processing image data with enhanced cache usage in storing metadata of stripes of different resolutions of an image frame according to some embodiments of the disclosure.

FIG. 9 shows a block diagram of example image frame processing using a reference image frame according to some embodiments of the disclosure.

FIG. 10 shows a block diagram of multiple stripes of a current image frame processed using stripes of a reference image frame stored in a cache according to some embodiments of the disclosure.

FIG. 11 shows a flow chart of an example method for processing image data with enhanced cache usage in storing stripes of a reference frame for processing of stripes of a current frame according to some embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image processing, including techniques for efficient cache usage in an image processing system. For example, the present disclosure provides systems, apparatus, methods, and computer-readable media that support efficient caching of image stripes in various image processing contexts.

Particular implementations of the subject matter described in this disclosure may be implemented to realize one or more of the following potential advantages or benefits. In some aspects, the present disclosure provides techniques for reduced cache usage when storing overlapping sections of image stripes in a cache until a final read of the stored overlapping sections from the cache is performed. For example, such storage may reduce cache usage through invalidation of the overlapping image stripe data when it is no longer needed in the cache, may reduce a number of write operations to the cache and cache usage by storing the overlapping section in the cache only once, may reduce power usage and latency through reading the stored overlapping image stripe data from the cache instead of from the memory, and may reduce a number of read operations from the memory by reading the overlapping section of the stripes from the memory only once. In some aspects, the present disclosure provides techniques for reduced cache usage when storing image stripe metadata for an image stripe of a first resolution until a final read of the image stripe metadata for processing of image stripes of a second resolution that depend on the image stripe metadata is complete. For example, such storage may reduce cache usage by invalidating the image stripe metadata after a final read of the image stripe metadata. Efficiency may be further increased by scheduling processing of the image stripes of the second resolution of the image frame that depend on the metadata of the image stripe of the first resolution to complete before processing of subsequent stripes of the first resolution. Furthermore, in some aspects, the present disclosure provides techniques for reduced cache usage when storing an image stripe of a reference frame in a cache and invalidating the image stripe of the reference frame based on a greatest motion vector between the reference frame and a current frame. For example, such storage may reduce cache usage by invalidating the image stripe of the reference frame stored in the cache when the image stripe of the reference frame is no longer needed for processing of a current frame.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device for capturing image frames using one or more image sensors, such as a smartphone, may include a configuration of one, two, three, four, or more camera modules on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames (such as through a bus) in a memory and/or provide the output image frames to processing circuitry (such as an applications processor). The processing circuitry may perform further processing, such as for encoding, storage, transmission, or other manipulation of the output image frames.

As used herein, a camera module may include the image sensor and certain other components coupled to the image sensor used to obtain a representation of a scene in image data comprising an image frame. For example, a camera module may include other components of a camera, including a shutter, buffer, or other readout circuitry for accessing individual pixels of an image sensor. In some embodiments, the camera module may include one or more components including the image sensor included in a single package with an interface configured to couple the camera module to an image signal processor or other processor through a bus.

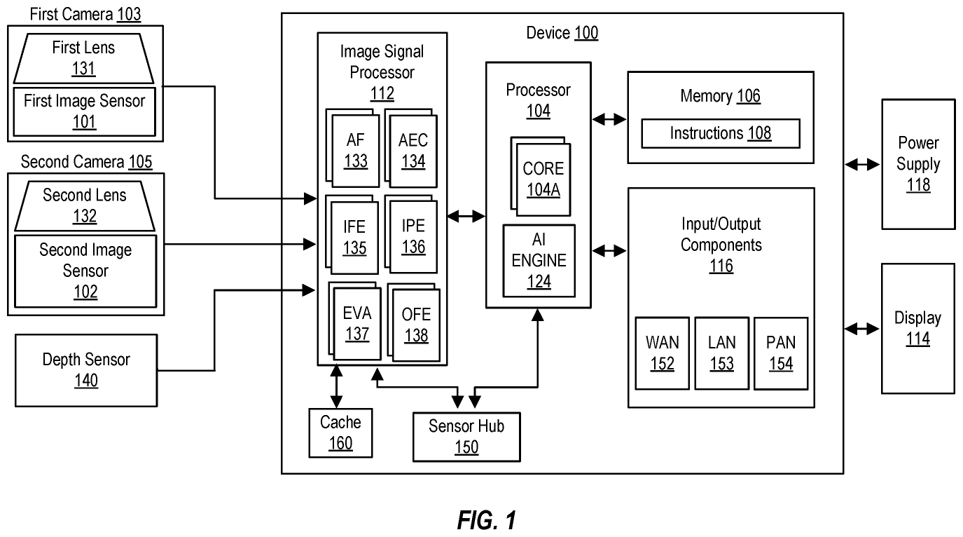

FIG. 1 shows a block diagram of a device 100 for performing image capture from one or more image sensors. The device 100 may include, or otherwise be coupled to, an image signal processor (e.g., ISP 112) for processing image frames from one or more image sensors, such as a first image sensor 101, a second image sensor 102, and a depth sensor 140. In some implementations, the device 100 also includes or is coupled to a processor 104 and a memory 106 storing instructions 108 (e.g., a memory storing processor-readable code or a non-transitory computer-readable medium storing instructions). The device 100 may also include or be coupled to a display 114 and components 116. Components 116 may be used for interacting with a user, such as a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one embodiment, a local bus connection couples the ISP 112 to the first image sensor 101 and second image sensor 102 of a first camera 103 and second camera 105, respectively. In another embodiment, a wire interface couples the ISP 112 to an external image sensor. In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data.

The digital image data may be formatted as one or more image frames, whether received from the first camera 103 and/or second camera 105 or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated an autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

Each of the first camera 103 and second camera 105 may be configured through hardware configuration and/or software settings to obtain different, but overlapping, field of views. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A variable aperture (VA) camera may have different characteristics that produced different representations of a scene based on a current aperture size. For example, a VA camera may capture image data with a depth of focus (DOF) corresponding to a current aperture size set for the VA camera.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mmWave, radio detection and ranging (Radar), and/or hybrid depth sensors, such as structured light sensors. In embodiments without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include specific hardware (such as one or more integrated circuits (ICs)) configured to perform one or more operations described in the present disclosure. For example, the ISP 112 may include image front ends (e.g., IFE 135), image post-processing engines (e.g., IPE 136), auto exposure compensation (AEC) engines (e.g., AEC 134), and/or one or more engines for video analytics (e.g., EVA 137).

In some embodiments, the ISP 112 may further include an optical filtering engines (e.g., OFE 138). An image pipeline may be formed by a sequence of one or more of the IFE 135, IPE 136, OFE 138, and/or EVA 137. In some embodiments, the image pipeline may be reconfigurable in the ISP 112 by changing connections between the IFE 135, IPE 136, OFE 138, and/or EVA 137. The AF 133, AEC 134, IFE 135, OFE 138, IPE 136, and EVA 137 may each include application-specific circuitry, be embodied as software or firmware executed by the ISP 112, and/or a combination of hardware and software or firmware executing on the ISP 112. In some embodiments, for example, the AF 133, the AEC 134, the IFE, 135, the IPE 136, the EVA 137, and/or the OFE 138 may each be assigned to one or more cores of the image signal processor 112.

The memory 106 may include a non-transient or non-transitory computer readable medium storing computer-executable instructions as instructions 108 to perform all or a portion of one or more operations described in this disclosure. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or second camera 105 and the ISP 112.

In addition to instructions 108, the memory 106 may also store image frames. The image frames may be output image frames stored by the ISP 112. The output image frames may be accessed by the processor 104 and/or ISP 112 for further operations. In some embodiments, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some embodiments, the device 100 is a system-on-chip (SoC) that incorporates the ISP 112, the processor 104, the sensor hub 150, the memory 106, and/or components 116 into a single package. The device 100 may further include a cache 160. The cache 160 may, in some embodiments be a cache for storing data for the ISP 112. In some embodiments, the cache 160 may store data for other components, such as processor 104. For example, image data may be stored in the cache 160 for rapid access by the image signal processor 112 when processing the image data.

In some embodiments, at least one of the ISP 112 or the processor 104 executes instructions to perform various operations described herein, including storing image data in and invalidating image data stored in the cache 160. For example, at least one of the ISP 112 or the processor 104 may execute the techniques described herein for efficient usage of the cache 160. In some embodiments, the processor 104 may include one or more general-purpose processor cores 104A-N capable of executing instructions to control operation of the ISP 112. For example, the cores 104A-N may execute a camera application (or other suitable application for generating images or video) stored in the memory 106 that activate or deactivate the ISP 112 for capturing image frames and/or control the ISP 112 in the application of efficient cache usage during processing of the image frames. The operations of the cores 104A-N and ISP 112 may be based on user input. For example, a camera application executing on processor 104 may receive a user command to begin a video preview display upon which a video comprising a sequence of image frames is captured and processed from first camera 103 and/or the second camera 105 through the ISP 112 for display and/or storage. Image processing to determine “output” or “corrected” image frames, such as according to techniques described herein, may be applied to one or more image frames in the sequence.

In some embodiments, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, face detection and/or object recognition performed using machine learning (ML) or artificial intelligence (AI). The AI engine 124 may be referred to as an Artificial Intelligence Processing Unit (AI PU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training. In some other embodiments, the device 100 does not include the processor 104, such as when all of the described functionality is configured in the ISP 112.

In some embodiments, the display 114 may include one or more suitable displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

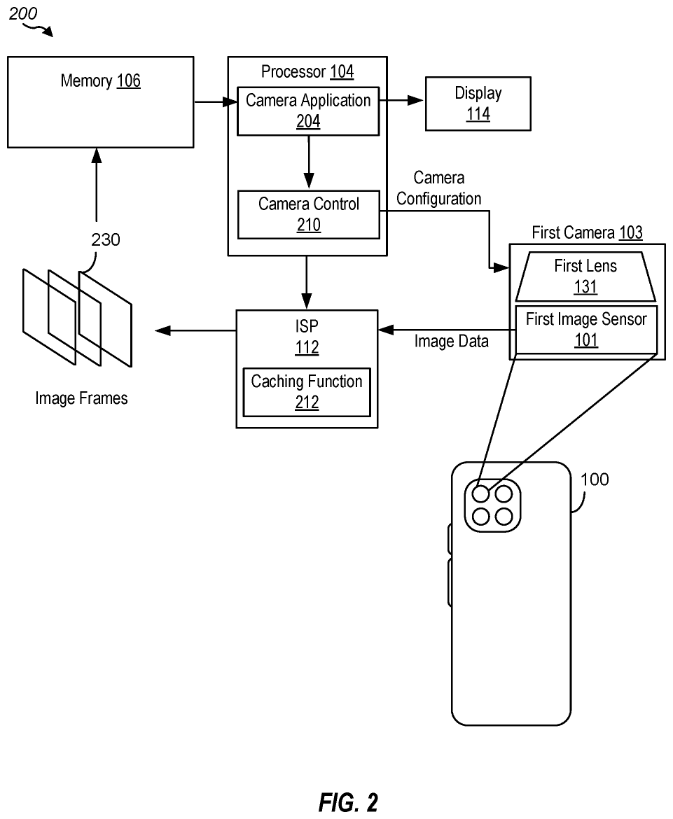

The exemplary image capture device of FIG. 1 may be operated to efficiently store and invalidate image data, such as image frame stripes, stripe metadata, and other image frame data, in the cache 160. One example method of processing image frames captured by one or more cameras, such as first camera 103 and/or second camera 105, with efficient cache usage techniques described herein, is shown in FIG. 2 and described below.

FIG. 2 is a block diagram illustrating an example data flow path for image data processing in an image capture device according to one or more embodiments of the disclosures. Processor 104 of system 200 may communicate with ISP 112 through a bi-directional bus and/or separate control and data lines. The processor 104 may control the first camera 103 through camera control 210. The camera control 210 may be a camera driver executed by the processor 104 for configuring the first camera 103, such as to active or deactivate image capture, configure exposure settings, and/or configure aperture size. Camera control 210 may be managed by a camera application 204 executing on the processor 104. The camera application 204 provides settings accessible to a user such that a user can specify individual camera settings or select a profile with corresponding camera settings. Camera control 210 communicates with the first camera 103 to configure the first camera 103 in accordance with commands received from the camera application 204. The camera application 204 may be, for example, a photography application, a document scanning application, a messaging application, or other application that processes image data acquired from the first camera 103.

The camera configuration may include parameters that specify, for example, a frame rate, an image resolution, a readout duration, an exposure level, an aspect ratio, an aperture size, etc. The first camera 103 may apply the camera configuration and obtain image data representing a scene using the camera configuration. In some embodiments, the camera configuration may be adjusted to obtain different representations of the scene. For example, the processor 104 may execute a camera application 204 to instruct the first camera 103, through camera control 210, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration.

In some embodiments in which the first camera 103 is a variable aperture (VA) camera system, the processor 104 may execute a camera application 204 to instruct the first camera 103 to configure to a first aperture size, obtain first image data from the first camera 103, instruct the first camera 103 to configure to a second aperture size, and obtain second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 corresponds to a larger aperture size than f/8.0.

The image data received from the first camera 103 may be processed in one or more blocks of the ISP 112 to determine output image frames 230 that may be stored in memory 106 and/or otherwise provided to the processor 104. The processor 104 may further process the image data to apply effects to the output image frames 230. Effects may include Bokch, lighting, color casting, and/or high dynamic range (HDR) merging. In some embodiments, the effects may be applied in the ISP 112.

The ISP 112 may process image frames captured by the first camera 103 and/or stored in the memory 106 to provide filtering, motion compensation, multi-pass processing, and other image processing techniques, which may enhanced image quality. In performing such operations, the ISP 112 may store portions of captured image frames in a cache for low-latency access by the ISP 112. The caching function 212 may govern when image frame data is stored in, read from, and invalidated in a cache associated with the ISP 112, such as cache 160 of FIG. 1. For example, the caching function 212 of the ISP 112 may control storage of portions of stripes of image frames, or metadata associated with stripes of image frames, until the portions of the stripes, or metadata associated with the stripes, have been read from a cache for a last time. The caching function 212 of the ISP 112 may also control invalidation of image frame data and metadata stored in a cahce, processing re-ordering for efficient caching, and other functions described herein.

The output image frames 230 by the ISP 112 may include representations of the scene improved by various image processing techniques using reduced caching resources, as described herein. The processor 104 may display these output image frames 230 to a user, and the improvements provided by the described processing implemented in the ISP 112 and/or processor 104 improve the image quality and the user experience by reducing the appearance of bright and dark regions in the photograph. Furthermore, a user experience may be improved through use of the techniques described herein, such as when performed by the caching function 212 of the ISP 112, through reduced latency and reduced cache usage in image processing.

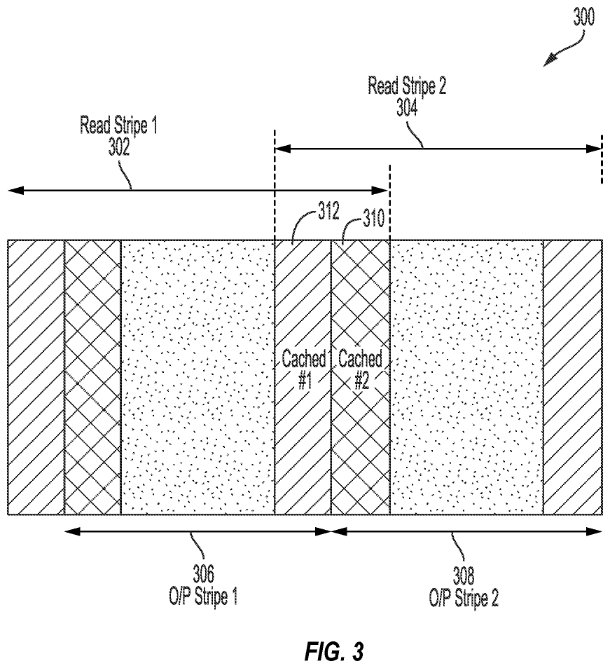

To facilitate efficient image processing, image frames may be divided into vertical cross-sections, referred to herein as stripes, for processing, such as for optical filtering and/or other image processing. Such stripes may partially overlap to preserve continuity in processing the image frame including the stripes. FIG. 3 shows an block diagram 300 of example overlapping stripes 302, 304 of an image frame according to some embodiments of the disclosure. Division of a frame into partially overlapping stripes 302, 304 may facilitate efficient filtering, as filters may sequentially process partially overlapping stripes of an image, rather than processing an entire image frame at a single time. A first stripe 302 of the image frame may partially overlap with a second stripe 304 of the image frame. For example, a first portion 312 and a second portion 310 of the first stripe 302 and the second stripe 304 may overlap. Following processing, the stripes 302, 304 may be output as non-overlapping stripes, such as a first output (O/P) stripe 306 and a second O/P stripe 308, to form a single image frame.

In some embodiments, the stripes 302, 304 may be in a universal bandwidth compression/decompression (UBWC) raw Bayer non-high dynamic range (HDR) format. In some embodiments, the image stripes 302, 304 may be in a UBWC HDR format. The UBWC HDR format image may be generated using a short anchor exposure for a baseline of a fusion process, or another anchor exposure based on a lighting condition of a scene captured in the image. Various stripe widths and overlapping region widths may be used, as such widths and region sizes determined according to a striping algorithm based on image processing pipeline parameters. As one particular example, overlapping region widths may be calculated based on image filters being applied to the image frame.

Caching efficiency during processing of overlapping stripes of an image frame may be enhanced by storing an overlapping portion of multiple stripes in a cache until all stripes sharing the overlapping section have been processed. For example, a processor, such as an image signal processor, may read the first stripe 302 from a memory at a first time. After reading the first stripe from the memory, the processor may store at least a portion of the first stripe 302, such as a portion 310, 312 of the first stripe 302 that overlaps a portion of the second stripe 304, in a cache associated with the processor. Such storage may be performed by issuing a read with allocate command to read the first stripe 302 from the memory and to allocate an area of the cache for storage of the overlapping portion 310, 312 of the first stripe 302 and the second stripe 304. In some embodiments, the processor may store the non-overlapping portion of the first stripe 302 in the cache as well.

The overlapping portion 310, 312 of the first stripe 302 stored in the cache may be maintained in the cache until the overlapping portion 310, 312 is read for processing of the second stripe 304. For example, the processor may read the portion 310, 312 of the first stripe 302 that overlaps with the second stripe 304 from the cache for processing of the second stripe 304 by issuing a read with evict command to read the overlapping portion 310, 312 from the cache and invalidate, such as evict, erase, or otherwise forget, the stored overlapping portion 310, 312 from the cache. The processor may also read the second stripe 304 from the memory. In some embodiments, the processor may read only the portion of the second stripe 304 from the memory that is not stored in the cache and may read the overlapping portion 310, 312 of the first stripe 302 and the second stripe 304 from the cache for processing of the second stripe 304. The processor may then process the second stripe 304 using the overlapping portion 310, 312 read from the cache and the non-overlapping portion of the second frame 304 read from the memory. Thus, an overlapping portion of multiple stripes may be stored in a cache until the overlapping portion is read, from the cache, for processing of a final image stripe that includes the overlapping portion.

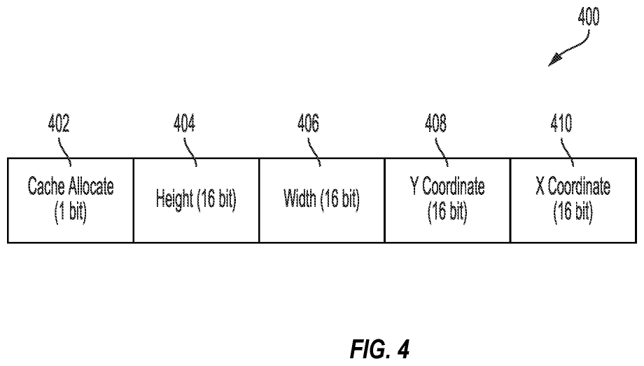

A command format for reading image frame stripe data from a memory may be adjusted to include instructions for allocating or not allocating cache space for storage of portions of a stripe of an image frame. FIG. 4 shows an example cache allocation command 400 for writing of portions of stripes of an image frame from a memory to a cache according to some embodiments of the disclosure. For example the command 400 may include a cache allocation bit 402 to indicate whether cache space should be allocated for storage of image frame stripe data associated with the command. The command 400 may also include a sixteen bit height field 404, a sixteen bit width field 406, a sixteen bit Y coordinate field 408, and a sixteen bit X coordinate field 410. In some embodiments, the cache allocation command 400 may be a read command.

The command 400 may, for example, may be a fetch request and may be transmitted from a port of an image correction and adjustment (ICA) engine, such as an ICA port having a Bayer UBWC or another UBWC format, to a fetch engine (FE). The FE may retrieve information requested by the ICA port and may provide the information to the ICA port via a serial input bus. If a value of the cache allocation bit 402 is set to 1 or true, cache space may be allocated for storage of an overlapping stripe section. If a value of cache allocation bit 402 is set to 0 or false, cache space may not be allocated, or may be de-allocated. The cache allocation bit 402 may be set by an ICA engine associated with the ICA port, and a software interface (SWI) may globally enable/disable an algorithm for setting the cache allocation bit 402.

In some examples, only a first and last tile of overlapping slices of an image frame may be cached, rather than an entire overlapping region. A system may, for example, include multiple respective fetch engines associated with respective fetch engine port IDs. For example, for some ports, such as ports of fetch engines operating according to Bayer UBWC or another UBWC format, a SWI will notify an FE of an initial x value and width of a stripe, a left tile cache enable and allocation for the stripe, for storage of a first overlapping left-side tile of the stripe, a number of left-side tiles of the stripe with overlapping pixels, a right cache enable and allocation for the stripe, for storage of a first overlapping right-side tile of the stripe, a number of right-side tiles with overlapping pixels, and an other tile cache enable and allocation for storage of other tiles of the stripe. If the output is linear, such as an output format different from UBWC, then caching may be disabled and overlapping tiles may not be stored in the cache. Otherwise the FE may determine a first and last tile in a stripe and may allocate cache storage space for the first and last tile of the stripe.

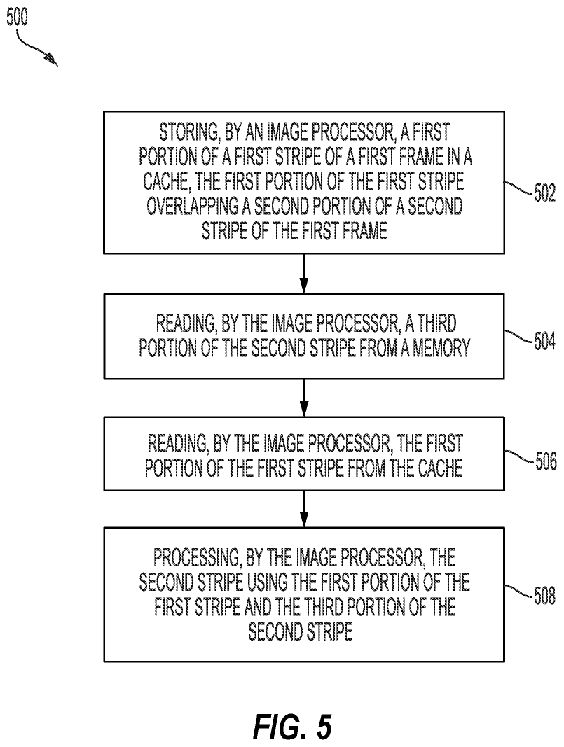

FIG. 5 shows a flow chart of an example method 500 for processing image data with enhanced cache usage in storing overlapping sections of image frame stripes according to some embodiments of the disclosure. The system 200 of FIG. 2 may be configured to perform the operations described with reference to the method 500 of FIG. 5 to reduce cache usage in processing image frames. Each of the operations described with reference to FIG. 5 may be performed by one or a combination of the processor 104 (including cores 104A-N or AI engine 124) and/or the ISP 112.

At block 502, an image processor may store a first portion of a first stripe of a first frame in a cache, the first portion of the first stripe overlapping a second portion of a second stripe of the first frame. For example, the image processor may read the first stripe of the first frame from a memory, such as a double data rate (DDR) synchronous dynamic random-access memory (SDRAM), and may store the first stripe of the first frame in the cache. In some embodiments, such storage may include generating a cache allocation command to allocate a first area of the cache for storage of the first portion of the first stripe. In some embodiments, the first portion of the first stripe may include a first tile of the first stripe and a second portion of the second stripe may include a second tile of the second stripe. Such tiles may, for example, be tiles of a UBWC tiled format of the first frame. In some embodiments, the first portion of the first stripe may be stored in the cache after the first portion of the first stripe is read from the memory for processing of the first stripe.

At block 504, the image processor may read a third portion of the second stripe from a memory. The third portion of the second stripe may, for example, be a portion of the second stripe that does not overlap with the second portion of the second stripe or the first portion of the first stripe. That is, the second portion of the second stripe may be a portion of the second stripe that does not overlap with the first stripe. In some embodiments, the image processor may read, from the memory, only a portion of the second stripe that is not already stored in the cache.

At block 506, the image processor may read the first portion of the first stripe from the cache. For example, the image processor may read the first portion of the first stripe for processing along with the third portion of the second stripe read from the memory. In some embodiments, after the image processor reads the first portion of the first stripe from the cache, the image processor may invalidate the first portion of the first stripe in the cache. Such invalidation may include de-allocating the portion of the cache allocated for storage of the first portion of the first stripe, forgetting the first portion of the first stripe, and/or evicting or deleting the first portion of the first stripe from the cache. For example, after reading the first portion of the first stripe from the cache for processing of a last stripe that includes the first portion of the first stripe, such as the second stripe, the image processor may issue a command, such as a staling command, to invalidate the first portion of the first stripe in the cache. Such invalidation may free cache space for other uses.

At block 508, the image processor may process the second stripe using the first portion of the first stripe read from the cache and the third portion of the second stripe read from the memory. For example, the image processor may perform one or more optical filtering operations on the second stripe, the second stripe including the first portion of the first stripe read from the cache and the third portion of the second stripe read from the memory. Thus, overlapping portions of adjacent image stripes may be stored in a cache until a final read of the overlapping portion for processing of a final stripe including the overlapping portion is performed.

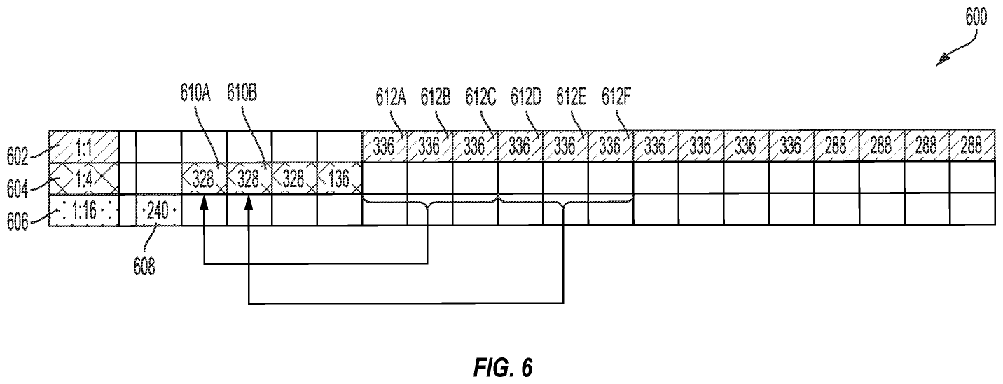

In some embodiments, multiple resolutions of an image frame may be processed, such as in multi-pass image processing. The multiple resolutions of a frame may be divided into multiple stripes, as described herein. Processing of stripes of a higher resolution of an image frame may depend on prior processing of stripes of a lower resolution of the image frame. For example, processing of stripes of a higher resolution of an image frame may depend on metadata generated during processing of stripes of the lower resolution of the image frame. FIG. 6 shows a block diagram of example processing dependencies between different stripes of different resolutions of an image frame according to some embodiments of the disclosure. As one particular example, a first, lowest, resolution 606 of a frame, such as a 1:16 resolution, may include a single stripe 608. A second resolution 604 of the frame, such as a 1:4 resolution, may include four stripes. Processing of each of the four stripes of the second resolution of the frame may depend on metadata generated in processing the first stripe 608 of the first resolution 606 of the frame. A third resolution 602 of the frame, such as a 1:1 resolution, may include 14 stripes. Processing of stripes 612A-C of the third resolution 602 may depend on metadata generated in processing stripe 610A of the second resolution 604, and processing of stripes 612D-F may depend on metadata generated in processing stripe 610B of the second resolution 604. Thus, stripes of a second resolution 604 may be mapped to stripes of a first resolution 606 on which they depend, and stripes of a third resolution 602 may be mapped to stripes of the second resolution 604 on which they depend. To facilitate efficient processing, metadata generated during processing of stripe 610A may be stored in a cache and read from the cache for processing each of the dependent stripes 612A-C. After the metadata generated during processing of stripe 610A is read for a last time for processing of stripe 612C, it may be invalidated in the cache, such as de-allocated, forgotten, erased, or evicted. Such invalidation may be performed, for example, by generating a staling notification each time a final stripe of the first resolution 602 of the image frame dependent on particular metadata is processed.

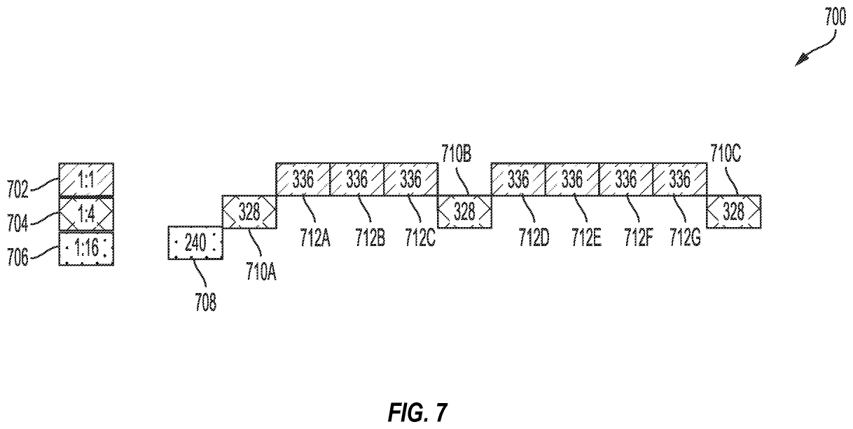

Cache usage efficiency when performing multi-pass image processing may be further enhanced through ordering of processing of stripes of an image frame based on dependencies between stripes of different resolutions. For example, instead of processing all stripes of the second resolution 604 before processing all stripes of the third resolution 606, processing of stripes of different resolutions may be scheduled in an interleaved pattern based on dependencies. FIG. 7 shows a block diagram 700 of example ordering of processing of different stripes of different resolutions of an image frame according to some embodiments of the disclosure. For example, a first resolution 706, a second resolution 704, and a third resolution 702 of a first frame may be processed. The first resolution 706 may include a single stripe 708, the second resolution 704 may include three stripes 710A-C, and the third resolution 702 may include eight stripes 712A-G, although different numbers of stripes of different resolutions may also be processed according to the techniques described herein. Processing of the three stripes 710A-C of the second resolution 704 may depend on metadata generated when processing the first stripe 708 of the first resolution 706. Processing of stripes 712A-C may depend on metadata generated during processing of stripe 710A, and processing of stripes 712D-G may depend on metadata generated during processing of stripe 710B. Processing of the stripes may be reordered such that dependent stripes are processed sequentially. In particular processing of stripes of different resolutions may be interleaved. For example, stripes 712A-C may be scheduled for processing following processing of stripe 710A and before processing of stripe 710B. Stripes 712D-G may be scheduled following processing of stripe 710B and before processing of stripe 710C. Metadata generated during processing of stripe 710A may be stored in a cache for use in processing stripes 712A-C until the metadata is read from the cache a final time for processing of stripe 712C. Then, the metadata may be invalidated in the cache. For example, after processing of stripe 712C, a processor may generate a notification, such as a staling notification, to invalidate the metadata associated with stripe 710A. In some embodiments, a processor may wait for a number of notifications to invalidate the data, following storage of the metadata in the cache, before invalidating the metadata from the cache. Such a number may be referred to as a staling distance. In some embodiments, a processor may generate a mapping dependency of stripes of the second resolution 704 to stripes of the first resolution 702.

As one particular example, a processor, such as an image signal processor, may schedule the first stripe 708 of the first resolution 706 for processing. The processor may schedule a first stripe 710A of the second resolution 704 for processing after the first stripe 708 of the first resolution 706. Metadata generated during processing of the first stripe 710A of the second resolution 704 may be stored in a cache associated with the processor. The processor may schedule stripes 712A-712C of the third resolution 702, such as full pass stripes, that depend on metadata generated during processing of the first stripe 710A of the second resolution 704 for processing after the first stripe 710A of the second resolution 704. The processor may schedule a forget notification for the metadata generated during processing of the first frame 710A of the second resolution 704 to invalidate the metadata stored in the cache after the metadata is no longer needed for processing stripes 712A-C. The forget notification may, for example, be a forget notification associated with a particular sub-cache identifier (SCID) associated with the metadata generated during processing of stripes of the second resolution 704, such as an SCID set when scheduling the first stripe 710A of the second resolution 704. The SCID may, for example, identify a location in the cache at which the particular metadata is stored. In some embodiments, the forget notification may be a staling notification. In some embodiments, when the forget notification is generated, the metadata associated with the stripe 710A may be invalidated without evicting the data, such as without writing the metadata to a memory. In some embodiments, the forget notification may cause a counter associated with the third resolution, such as a staling counter, to be incremented. For example, after processing of each set of stripes of the third resolution 702 that depend from the second resolution 704, a counter may be incremented in response to a forget notification. The processor may be configured to invalidate the metadata stored in the cache when the counter reaches a predetermined value, such as when the counter increments a threshold number of times following storage of particular metadata associated with a particular stripe in the cache. For example, the processor may be configured to invalidate the metadata generated during processing of the stripe 710A when the counter increments two times following storage of the metadata associated with the stripe 710A in the cache, such as after processing of stripe 712G. When the forget notification is generated a blocking write may be performed on an identified register, such as to update a staling counter.

The processor may be configured to schedule a second stripe 710B of the second resolution 704 after scheduling the set of stripes 712A-C of the third resolution 702. The processor may be further configured to schedule a second set of stripes 712D-G of the third resolution 702, which depend on metadata generated during processing of the second stripe 710B of the second resolution 704, following processing of the second stripe 710B of the second resolution 704. Likewise, the processor may schedule a forget notification for the metadata associated with the second resolution 704, such as a staling notification, for incrementing a counter for metadata associated with the second resolution 704. In some embodiments, different queues, such as different queues associated with different resolutions, may be assigned different SCIDs. Thus, for example, an SCID for the first resolution 706 may be different from an SCID for the second resolution 704. Furthermore, a staling distance, such as an amount of increase of a staling counter at which metadata associated with the resolution is invalidated in the cache, may be set to a different value for each SCID. For example, a staling distance associated with a staling counter for the second resolution 704 may be set to 2, such that when two staling notifications for the SCID associated with the second resolution 704 are received after metadata generated during processing of a stripe of the second resolution 704 is stored in the cache the metadata will be invalidated in the cache. A staling distance associated with a staling counter for the first resolution 708 may be set to 1, such that when one staling notification for the SCID associated with the first resolution 706 is received after the metadata generated during processing of a stripe of the first resolution 706 is stored in the cache the metadata will be invalidated in the cache. Thus, staling counters for different resolutions may be independent. The scheduling of processing of stripes and forget notifications may, for example, be performed by firmware executed by the processor.

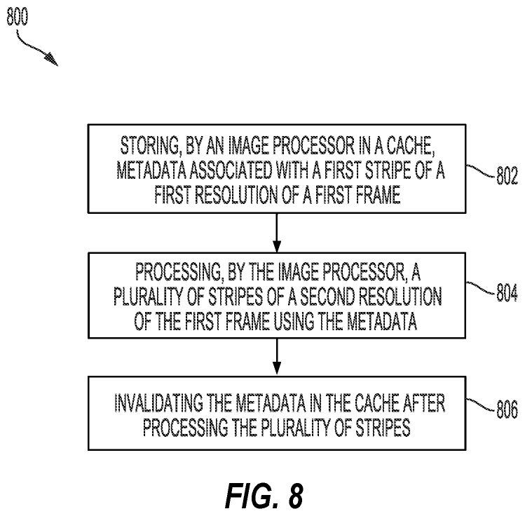

FIG. 8 shows a flow chart of an example method 800 for processing image data with enhanced cache usage in storing metadata of stripes of different resolutions of an image frame according to some embodiments of the disclosure. The system 200 of FIG. 2 may be configured to perform the operations described with reference to the method 800 of FIG. 8 to reduce cache usage and enhance efficiency in processing image frames. Each of the operations described with reference to FIG. 8 may be performed by one or a combination of the processor 104 (including cores 104A-N or AI engine 124) and/or the ISP 112.

At block 802, an image processor, such as an image signal processor, may store metadata associated with a first stripe of a first resolution of a first image in a cache. The metadata may, for example, be metadata generated during processing of the first stripe of the first resolution. In some embodiments, the image processor may schedule processing of the first stripe of the first resolution to generate the metadata. In some embodiments, the first resolution may be a 1:4 resolution.

At block 804, the image processor may process a plurality of stripes of a second resolution of the first frame using the metadata. For example, the processor may determine that the plurality of stripes of the second resolution depend on the metadata associated with the first stripe of the first resolution and may schedule the plurality of stripes for processing after the first stripe of the first resolution and before processing of any other stripes of the first resolution. Processing of the plurality of stripes of the second resolution may, for example, include reading, at a first time, the metadata from the cache, processing a second stripe of the plurality of stripes using the metadata read from the cache at the first time, reading, at a second time, the metadata from the cache, and processing a third stripe of the plurality of stripes using the metadata read from the cache at the second time. In some embodiments, the third stripe may be a last stripe of the plurality of stripes of the second resolution, such as a last stripe of the second resolution that depends on the metadata associated with the first stripe of the first resolution. In some embodiments, the image processor may schedule reading of the metadata from the cache at the second time and may also schedule incrementing of a counter associated with the metadata, after the metadata is read the second time. In some embodiments, the counter may be a staling counter and scheduling incrementing of the counter may include generating a forget notification, such as a staling notification. Scheduling of the incrementing of the counter may, for example, be based on a determination that the third stripe is a last stripe of the plurality of stripes of the second resolution that depend on the metadata. In some embodiments, the second resolution may be a 1:1 resolution.

At block 806, the processor may invalidate the metadata in the cache after processing the plurality of the stripes. Invalidating the metadata may include de-allocating the portion of the cache allocated for storage of the first portion of the first stripe and/or deleting the first portion of the first stripe from the cache. In some embodiments, the metadata may be invalidated without evicting the data, such as without writing the metadata to a memory. In some embodiments, invalidating the metadata may be performed based on incrementing the counter associated with the metadata described with respect to block 804. For example, invalidating the metadata may be performed based on the counter exceeding a threshold value, such as two or another value. For example, the metadata associated with the first stripe may be invalidated after processing a second plurality of stripes of the second resolution that depend on metadata associated with a second stripe of the first resolution. Thus, processing of stripes of different resolutions of an image frame may be re-ordered to enhance cache usage efficiency.

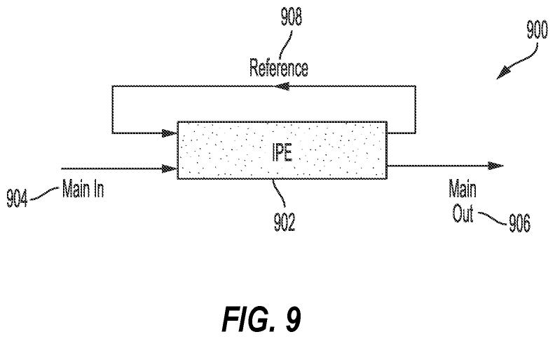

Cache usage efficiency may be further enhanced through invalidation of stripes of a reference frame stored in a cache for processing stripes of a current frame based on a greatest motion vector between the reference frame and the current frame. FIG. 9 shows a block diagram 900 of example processing using a reference image frame according to some embodiments of the disclosure. Such processing may, for example, include processing to enhance a current image frame based on motion detected between a reference image frame and the current image frame. For example, a reference frame 908 may be input to and processed by an image processing engine 902. The reference image frame 908, after processing, may be stored in cache. Subsequently, a current frame may be input to the image processing engine 902 at input 904, processed by the image processing engine 902 using the reference image frame 908 loaded from the cache, and output at a main output 906.

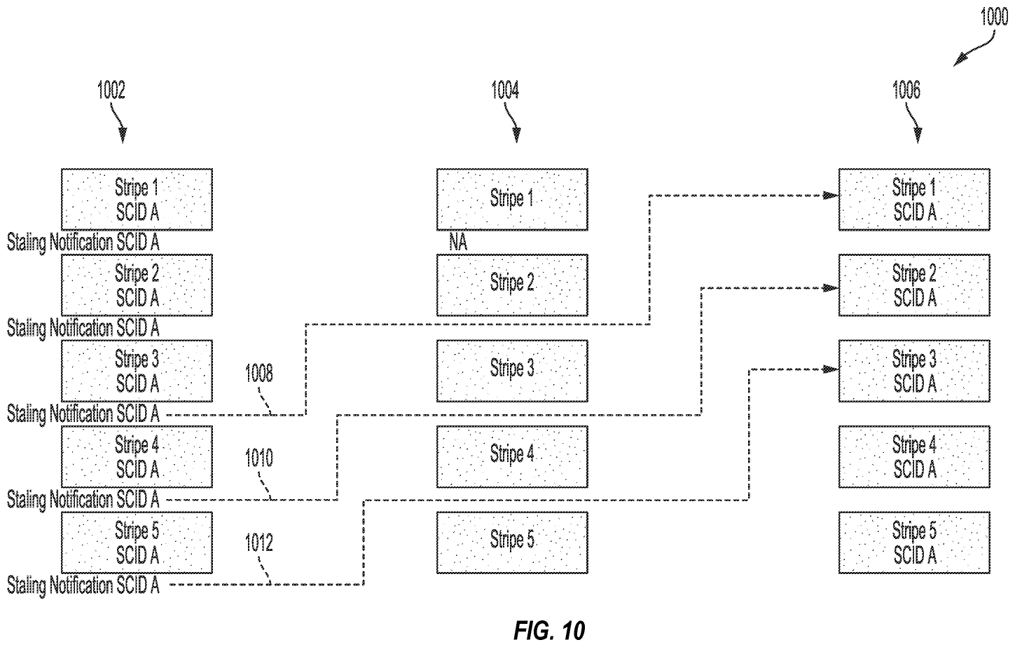

A reference image frame and a current image frame may be divided into stripes, as discussed herein, for efficient processing. For example, as shown in FIG. 10, a plurality of stripes 1002 of a current image frame, associated with a first SCID, may be processed using a plurality of stripes 1006 of a reference image frame, previously processed by an image processor and stored in a cache. For example, the plurality of stripes of the reference frame may be read as stripes 1004 from the cache for processing of the current image frame 1002 image frame. With every stripe of an image processed, a forget notification, such as a staling notification, may be generated by the image processor. The forget notification may cause a counter associated with the stripes of the reference frame stored in the cache to be incremented. When the counter increases a threshold amount after storage of a particular stripe of the reference frame in the cache, the stripe of the reference frame stored in the cache may be invalidated. For example a forget notification associated with an SCID associated with the reference frame may be generated every time a stripe of the reference frame 1006 or the current frame 1002 is processed.

To efficiently utilize cache space when processing stripes of a current frame using stripes of a reference frame, stripes of the reference frame stored in the cache may be invalidated based on a greatest motion vector between the reference frame and the current frame. For example, a threshold, such as a staling distance for a counter, such as a staling distance, may be set based on a value of a greatest motion vector between the reference frame and the current frame. Such setting may include activating or deactivating the counter based on the greatest motion vector between the reference frame and the current frame. When the counter is activated and increments a threshold number of times after storage of a stripe of a reference frame in the cache, the stripe of the reference frame may be invalidated in the cache.

A greatest motion vector between the reference frame and the current frame may be determined by determining a motion vector with a greatest value among a plurality of motion vectors calculated by different image processing cores and/or functions. For example, the greatest motion vector may be determined by reading a maximum negative x direction motion vector from each of multiple different image processing algorithms and summing the maximum negative motion vectors for a total maximum negative motion vector. The greatest motion vector may, for example, be a greatest motion vector along an X-axis.

A minimum strip width of the reference frame and the current frame may then be determined. The minimum strip width may, for example, be the same for both the reference frame. Therefore, the minimum strip width determined may be a minimum strip width corresponding to both the reference frame and the current frame. In some embodiments, a determination may be made of whether the maximum motion vector value is greater than two times the minimum stripe width. If so, the counter may be disabled and the stripes of the reference frame may not be invalidated based on the greatest motion vector between the reference frame and the current frame. If not, the counter may be set to a number of stripes of the reference frame and/or the current frame plus three. Thus, as one particular example, a first stripe of the reference frame 1006 may be invalidated in the cache when a notification 1008 to increment the counter based on processing of a third stripe of the current frame 1002 is generated. Likewise, a second stripe of the reference frame 1006 may be invalidated in the cache when a notification 1010 to increment the counter based on processing of a fourth stripe of the current frame 1002 is received. A third stripe of the reference frame 1006 may be invalidated in the cache when a notification 1012 to increment the counter based on processing of a fifth stripe of the current frame 1002 is received.

In some embodiments, a different value, such as three times the minimum stripe width, may be compared with the value of the greatest motion vector. Then, the counter may be set to a number of stripes of the reference frame and/or the current frame plus four. Other numbers of minimum stripes may also be compared with the value of the greatest motion vector for similar calculations.

If the counter is not disabled, every command to write a stripe to the cache may be appended with a notification to increment the counter, such as a staling notification. When the counter increments the threshold number of times following storage of a particular stripe of a reference frame in the cache, such as 26 times, the stripe may be invalidated in the cache. The counter may, in some embodiments, have a size of five bits. In some embodiments, the counter may be stored in the cache.

A number of stripes in an 8 k image frame may be 23, in which case a counter may be set to 26 when a greatest motion vector is compared against a width of two stripes. A number of stripes in an ultra high definition (UHD) image frame may be 14, in which case a counter may be set to 17 when a greatest motion vector is compared against a width of two stripes. A number of stripes in a full high definition (FHD) image frame may be 8, in which case a counter may be set to 11 when a greatest motion vector is compared against a width of two stripes. In some embodiments a maximum value of the counter, such as a maximum staling distance, may be 32. In some embodiments, a maximum value of the counter may be limited to 27 to prevent wrap around conditions. In some embodiments, the threshold values associated with the counter and deactivation and/or activation of the counter may be determined per frame by firmware, such as at a start of processing a frame. Firmware may further set a no self-evict (NSE) value to true.

In some embodiments, if a number of stripes in the current frame or the reference frame is greater than 23, the counter may be disabled and the stripes of the reference frame stored in the cache may not be invalidated based on the counter. In some embodiments, if a downscale or upscale factor changes between a reference frame and a current frame, the counter and caching of the reference frame may be disabled. In some embodiments, the counter and caching of the reference frame may be disabled for processing of video super-resolution (VSR) image frames. In some embodiments, caching of a current frame may be disabled by a UC upon detection of any change in striping, such as a change in stripe width. Upon detection of such a change, all cached reference frame data may be evicted to a memory, such as a double data rate (DDR) synchronous dynamic random-access memory (SDRAM).

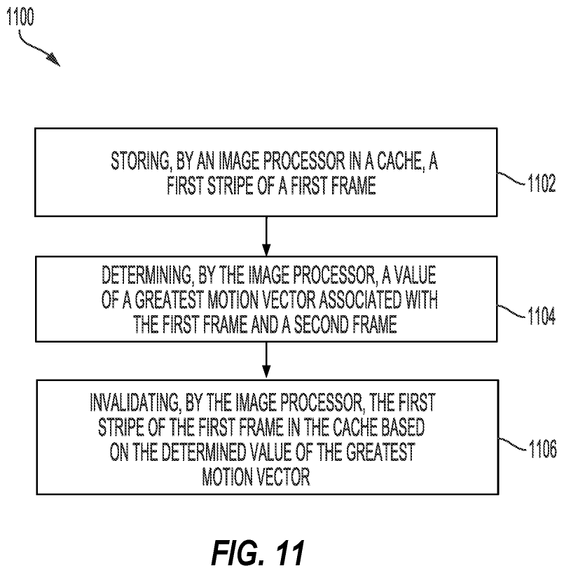

FIG. 11 shows a flow chart of an example method 1100 for processing image data with enhanced cache usage in storing stripes of a reference frame for processing of stripes of a current frame according to some embodiments of the disclosure. The system 200 of FIG. 2 may be configured to perform the operations described with reference to the method 1100 of FIG. 11 to reduce cache usage and enhance efficiency in processing image frames. Each of the operations described with reference to FIG. 11 may be performed by one or a combination of the processor 104 (including cores 104A-N or AI engine 124) and/or the ISP 112.

At block 1102, an image processor may store, in a cache, a first stripe of a first frame. The first stripe of the first frame may, for example, be a first stripe of a reference frame. In some embodiments, a counter, such as a staling counter, may be initiated and/or incremented when the first stripe of the first frame is stored in the cache. The first stripe of the first frame may, for example, be stored in the cache after processing of the first stripe of the first frame.

At block 1104, the image processor may determine a value of a greatest motion vector associated with the first frame and a second frame. The second frame may, for example, be a current frame. The greatest motion vector may, for example, be a motion vector having a greatest value associated with an x-axis of the motion vector. The determination may, for example, include determining one or more motion vectors between the first and second frames along an x-axis determined by one or more image processing cores or functions. In some embodiments the one or more motion vectors may be summed to determine a greatest motion vector. In some embodiments, the one or more motion vectors may be compared to determine a motion vector with a greatest value along the x-axis to determine the greatest motion vector. In some embodiments the value of the greatest motion vector may be determined at block 1104 prior to storing the first stripe of the first frame in a cache at block 1102.

In some embodiments, a counter associated with the first stripe, such as a staling counter, may be set in accordance with the determined value of the greatest motion vector associated with the first frame and the second frame. For example, a counter may be deactivated if a value of the greatest motion vector along an x-axis is greater than or equal to a width of a threshold number of stripes of the first frame. For example, if the length of the greatest motion vector exceeds a width of two stripes, or another number of stripes, of the first frame, the counter may be deactivated. If the length of the greatest motion vector is below a width of two stripes, the counter may be activated and a threshold value for the counter may be set to a number of stripes in the reference frame plus three. In some embodiments, the counter may be set to a number of stripes of the reference frame plus a different integer value. The different integer value may, for example, be set based on comparing the length of the greatest motion vector against a width of a different number of stripes. The counter may be incremented every time a stripe of the reference frame or the current frame is processed and stored in the cache.

As one particular example, the image processor may read a second stripe of the second frame, such as a stripe of the current frame, from a memory, and may read the first stripe of the first frame, such as the stripe of the reference frame, from the cache. The image processor may then process the second stripe of the second frame using the first stripe of the first frame and may store the second stripe of the second frame in the cache. The image processor may increment the counter associated with the first stripe of the first frame in response to processing the second stripe of the second frame. For example, the image processor may generate a staling notification to increment the counter. In some embodiments incrementing the counter may be triggered by storage of the second stripe of the second frame in the cache or by another operation. In some embodiments a single counter may be used and incremented in accordance with every notification associated with processing of stripes of the first and second frames, and the counter may be monitored to determined when the counter has incremented a threshold number of times following storage of a particular stripe in the cache. For example, the image processor may determine that the counter has exceeded a threshold value associated with the greatest motion vector. Such a determination may trigger the invalidation described with respect to block 1106.

At block 1106, the image processor may invalidate the first stripe of the first frame in the cache based on the determined value of the greatest motion vector. For example, the image processor may invalidate the first stripe of the first frame in the cache in accordance with activation of a counter based on the determined value of the greatest motion vector and in accordance with the counter incrementing a threshold number of times following storage of the first stripe of the first frame in the cache. Thus, stripes of a reference frame may be invalidated in a cache based on a greatest motion vector between the reference frame and a current frame.

In one or more aspects, techniques for supporting image processing may include additional aspects, such as any single aspect or any combination of aspects described below or in connection with one or more other processes or devices described elsewhere herein. In a first aspect, supporting image processing may include an apparatus configured to perform operations including storing, by an image processor, a first portion of a first stripe of a first frame in a cache, the first portion of the first stripe overlapping a second portion of a second stripe of the first frame, reading, by the image processor, a third portion of the second stripe from a memory, reading, by the image processor, the first portion of the first stripe from the cache, and processing, by the image processor, the second stripe using the first portion of the first stripe and the third portion of the second stripe.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the apparatus is further configured to perform operations including reading, by the image processor, the first stripe of the first frame from the memory before storing the first portion of the first stripe in the cache.

In a third aspect, in combination with one or more of the first aspect or the second aspect, the first portion of the first stripe comprises a first tile of the first stripe, and wherein the second portion of the second stripe comprises a second tile of the second stripe.

In a fourth aspect, in combination with one or more of the first aspect through the third aspect, the third portion of the second stripe does not overlap the second portion of the second stripe.

In a fifth aspect, in combination with one or more of the first aspect through the fourth aspect, storing the first portion of the first stripe in the cache comprises generating, by the image processor, a command to allocate a first area of the cache for storage of the first portion of the first stripe.

In a sixth aspect, in combination with one or more of the first aspect through the fifth aspect, a format of the first frame is a universal bandwidth compression/decompression (UBWC) tiled format.

In a seventh aspect, in combination with one or more of the first aspect through the sixth aspect, the apparatus is further configured to perform operations including invalidating, by the image processor, the first portion of the first stripe in the cache after reading the first portion of the first stripe from the cache.

In an eighth aspect, the apparatus may be configured to perform operations including storing, by an image processor in a cache, metadata associated with a first stripe of a first resolution of a first frame, processing, by the image processor, a plurality of stripes of a second resolution of the first frame using the metadata, and invalidating the metadata in the cache after processing the plurality of stripes.

In a ninth aspect, in combination with the eighth aspect, processing the plurality of stripes includes reading, at a first time, the metadata from the cache, processing a second stripe of the plurality of stripes using the metadata read from the cache at the first time, reading, at a second time, the metadata from the cache, and processing a third stripe of the plurality of stripes using the metadata read from the cache at the second time.

In a tenth aspect, in combination with one or more of the eighth aspect through the ninth aspect, the third stripe is a last stripe of the plurality of stripes.

In an eleventh aspect, in combination with one or more of the eighth aspect through the tenth aspect, the apparatus is further configured to perform operations including scheduling, by the image processor, reading of the metadata from the cache, at the second time and scheduling, by the image processor, incrementing of a counter associated with the metadata, after the metadata is read at the second time, wherein invalidating the metadata is performed based on incrementing of the counter.

In a twelfth aspect, in combination with one or more of the eighth aspect through the eleventh aspect, invalidating the metadata is further performed based on the counter exceeding a threshold value.

In a thirteenth aspect, in combination with one or more of the eighth aspect through the eighth aspect, scheduling the incrementing the counter comprises generating a staling notification, and wherein the counter comprises a staling counter.

In a fourteenth aspect, in combination with one or more of the eighth aspect through the thirteenth aspect, the apparatus is further configured to perform operations including scheduling, by the image processor, the first stripe for processing and scheduling, by the image processor, the plurality of stripes for processing after the first stripe.

In a fifteenth aspect, in combination with one or more of the eighth aspect through the fourteenth aspect, the apparatus is further configured to perform operations including determining, by the image processor, that processing the plurality of stripes depends on the metadata associated with the first stripe, wherein scheduling the plurality of stripes for processing after the first stripe is performed based on the determination that processing the plurality of stripes depends on the metadata associated with the first stripe.

In a sixteenth aspect, in combination with one or more of the eighth aspect through the fifteenth aspect, the first resolution is a 1:4 resolution, and wherein the second resolution is a 1:1 resolution.

In a seventeenth aspect, the apparatus is configured to perform operations including storing, by an image processor in a cache, a first stripe of a first frame, determining, by the image processor, a value of a greatest motion vector associated with the first frame and a second frame, and invalidating, by the image processor, the first stripe of the first frame in the cache based on the determined value of the greatest motion vector.

In an eighteenth aspect, in combination with the seventeenth aspect, the greatest motion vector is a motion vector having a greatest value associated with an x-axis.

In a nineteenth aspect, in combination with one or more of the seventeenth aspect through the eighteenth aspect, reading, by the image processor, a second stripe of the second frame from a memory, reading, by the image processor, the first stripe of the first frame from the cache, processing, by the image processor, the second stripe of the second frame using the first stripe of the first frame, incrementing, by the image processor, a counter associated with the first stripe of the first frame in response to processing the second stripe of the second frame, and determining, by the image processor, the counter exceeds a threshold value associated with the greatest motion vector, wherein invalidating, by the image processor, the first stripe of the first frame in the cache based on the determined value of the greatest motion vector is performed based on the counter exceeding the threshold value.

In a twentieth aspect, in combination with one or more of the seventeenth aspect through the nineteenth aspect, the counter comprises a staling counter and wherein incrementing the counter comprises generating a staling notification.

In a twenty-first aspect, in combination with one or more of the seventeenth aspect through the twentieth aspect, the apparatus is further configured to perform operations including determining a number of stripes of the first frame corresponding to the value of the greatest motion vector and adding an integer value to the number of stripes to determine the threshold value.

In a twenty-second aspect, in combination with one or more of the seventeenth aspect through the twenty-first aspect, the integer value is three.

In a twenty-third aspect, in combination with one or more of the seventeenth aspect through the twenty-second aspect, determining a greatest motion vector associated with the first frame and the second frame comprises determining a greatest motion vector of a plurality of motion vectors associated with the first frame and the second frame determined by a plurality of cores of the image processor.

In the figures, a single block may be described as performing a function or functions. The function of functions performed by that block may be performed in a single component of across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation descisions should not be interpreted as causing a departure from the scope of the present disclosure. Also, the example devices may include components other than those shown, including well-known components such as processor, memory, and the like.

Aspects of the present disclosure are applicable to any electronic device including coupled to, or otherwise processing data from one, two, or more image sensors capable of capturing image frames (or “frames”). The terms “output image frame,” “modified image frame,” and “corrected image frame” may refer to an image frame that has been processed by any of the disclosed techniques to adjust raw image data received from an image sensor. Further, aspects of the disclosed techniques may be implemented for processing image data received from image sensors of the same or different capabilities and characteristics (such as resolution, shutter speed, or sensor type). Further, aspects of the disclosed techniques may be implemented in devices for processing image data, whether or not the device includes or is coupled to image sensors. For example, the disclosed techniques may include operations performed by processing devices in a cloud computing system that retrieve image data for processing that was previously recorded by a separate device having image sensors.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “meausring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions of processes of a computer system does not necessarily indicate different operations. For example, “determining” data may refer to “generating” data. As another example, “determining” data may refer data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sensing,” “means for using,” “means for selecting,” “means for determining,” “means for normalizing,” “means for multiplying,” or other similarly, named terms referring to one or more operations on data, such as image data, may refer to processing circuitry (e.g., application specific integrated circuitys (ASICs), digital signal processors (DSP), graphics processing unit (CPU), central processing unit (CPU), computer vision processor (CVP), or neural signal processor (NSP)), configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) describe with reference to FIGS. 5, 8, and 11 may be combined with one or more blocks (or operations) described with reference to another of the figures. For example, one or more blocks for operations) of FIG. 5 may be with one or more blocks (or operations) of FIGS. 1-2. As another example, one or more blocks associated with FIG. 8 may be combined with one or more blocks (or operations) associated with FIGS. 1-2.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. When such functionality is implemented as hardware or software depends upon the particular application and design constraints imposed on the overall system. Skilled artisans may implement the described functionality in g ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on overall system.

The hardware and data processing apparatus used to implement the various illustrative logics, logical blocks, modules and circuits described in connection with the aspects disclosed herein may be implemented or performed with a general purpose single-multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic try, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instruction or code on a computer-readable medium. The processes of a method or algorithm disclosed herein may be implemented in a processor-executable software module which may reside on a computer-readable medium. Computer-readable media includes both computer storage media and communication media including any medium that may be any available media that may be accessed by a computer. By way of media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes u for ease of describing the figures, and indicate relative positions corresponding to the orientations of the figure on a properly oriented page, and may not reflect the proper orientation of any device as implemented.

Certain features that are described in this specification in the context of separate implementation also may be implemented in combination in a single implementation. Conversely, various feature that are described in the context of a single implementation also may be implemented in multiple implementations separately or in any suitable subcombination. Moreover, although features may be described above as acting in certain combinations and even initially claimed as such, one or more features from a claimed combination may in some ca be from the combination, and the claimed combination may be directed to a subcombination or variation of a subcombination.

Similarly, while operations are depicted in the drawings in a particular order, this should not be understood as requiring that such operations be performed in the particular order shown, in sequential order, or that all illustrated operations be performed to achieve desirable results. Further, the drawings may be schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or package into multiple software products. Additionally, some other implementations are within the scope of the following claims. In some cases, the actions recited in the claims may be performed in a different order and still achieve desirable results.

As used herein, including in the claims, term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; of A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, comprising:
storing, by an image processor, a first portion of a first stripe of a first frame in a cache, the first portion of the first stripe overlapping a second portion of a second stripe of the first frame;
reading, by the image processor, a third portion of the second stripe from a memory;
reading, by the image processor, the first portion of the first stripe from the cache; and
processing, by the image processor, the second stripe using the first portion of the first stripe and the third portion of the second stripe.

2. The method of claim 1, further comprising:
reading, by the image processor, the first stripe of the first frame from the memory before storing the first portion of the first stripe in the cache.

3. The method of claim 1, wherein the first portion of the first stripe comprises a first tile of the first stripe, and wherein the second portion of the second stripe comprises a second tile of the second stripe.

4. The method of claim 1, wherein the third portion of the second stripe does not overlap the second portion of the second stripe.

5. The method of claim 1, wherein storing the first portion of the first stripe in the cache comprises:
generating, by the image processor, a command to allocate a first area of the cache for storage of the first portion of the first stripe.

6. The method of claim 1, wherein a format of the first frame is a universal bandwidth compression/decompression (UBWC) tiled format.

7. The method of claim 1, further comprising:
invalidating, by the image processor, the first portion of the first stripe in the cache after reading the first portion of the first stripe from the cache.

8. An apparatus, comprising:
a memory storing processor-readable code; and
at least one processor coupled to the memory, the at least one processor configured to execute the processor-readable code to cause the at least one processor to perform operations including:
storing a first portion of a first stripe of a first frame in a cache, the first portion of the first stripe overlapping a second portion of a second stripe of the first frame;
reading a third portion of the second stripe from the memory;
reading the first portion of the first stripe from the cache; and
processing the second stripe using the first portion of the first stripe and the third portion of the second stripe.

9. The apparatus of claim 8, wherein the at least one processor is further configured to execute the processor-readable code to cause the at least one processor to perform operations including:
reading first stripe of the first frame from the memory before storing the first portion of the first stripe in the cache.

10. The apparatus of claim 8, wherein the first portion of the first stripe comprises a first tile of the first stripe, and wherein the second portion of the second stripe comprises a second tile of the second stripe.

11. The apparatus of claim 8, wherein the third portion of the second stripe does not overlap the second portion of the second stripe.

12. The apparatus of claim 8, wherein storing the first portion of the first stripe in the cache comprises:
generating a command to allocate a first area of the cache for storage of the first portion of the first stripe.

13. The apparatus of claim 8, wherein a format of the first frame is a universal bandwidth compression/decompression (UBWC) tiled format.

14. The apparatus of claim 8, wherein the at least one processor is further configured to execute the processor-readable code to cause the at least one processor to perform operations including:
invalidating the first portion of the first stripe in the cache after reading the first portion of the first stripe from the cache.

15. A method, comprising:
storing, by an image processor in a cache, metadata associated with a first stripe of a first resolution of a first frame;
processing, by the image processor, a plurality of stripes of a second resolution of the first frame using the metadata; and
invalidating the metadata in the cache after processing the plurality of stripes.

16. The method of claim 15, wherein processing the plurality of stripes includes:
reading, at a first time, the metadata from the cache;
processing a second stripe of the plurality of stripes using the metadata read from the cache at the first time;
reading, at a second time, the metadata from the cache; and
processing a third stripe of the plurality of stripes using the metadata read from the cache at the second time.

17. The method of claim 16, wherein the third stripe is a last stripe of the plurality of stripes.

18. The method of claim 17, further comprising:
scheduling, by the image processor, reading of the metadata from the cache, at the second time; and
scheduling, by the image processor, incrementing of a counter associated with the metadata, after the metadata is read at the second time,
wherein invalidating the metadata is performed based on incrementing of the counter.

19. The method of claim 18, wherein invalidating the metadata is further performed based on the counter exceeding a threshold value.

20. The method of claim 18, wherein scheduling the incrementing the counter comprises generating a staling notification, and wherein the counter comprises a staling counter.

21. The method of claim 15, further comprising:
scheduling, by the image processor, the first stripe for processing; and
scheduling, by the image processor, the plurality of stripes for processing after the first stripe.

22. The method of claim 21, further comprising:
determining, by the image processor, that processing the plurality of stripes depends on the metadata associated with the first stripe,
wherein scheduling the plurality of stripes for processing after the first stripe is performed based on the determination that processing the plurality of stripes depends on the metadata associated with the first stripe.

23. The method of claim 15, wherein the first resolution is a 1:4 resolution, and wherein the second resolution is a 1:1 resolution.

24. A method, comprising:
storing, by an image processor in a cache, a first stripe of a first frame;
determining, by the image processor, a value of a greatest motion vector associated with the first frame and a second frame; and
invalidating, by the image processor, the first stripe of the first frame in the cache based on the determined value of the greatest motion vector.

25. The method of claim 24, wherein the greatest motion vector is a motion vector having a greatest value associated with an x-axis.

26. The method of claim 24, further comprising:
reading, by the image processor, a second stripe of the second frame from a memory;
reading, by the image processor, the first stripe of the first frame from the cache;
processing, by the image processor, the second stripe of the second frame using the first stripe of the first frame;
incrementing, by the image processor, a counter associated with the first stripe of the first frame in response to processing the second stripe of the second frame; and
determining, by the image processor, the counter exceeds a threshold value associated with the greatest motion vector,
wherein invalidating, by the image processor, the first stripe of the first frame in the cache based on the determined value of the greatest motion vector is performed based on the counter exceeding the threshold value.

27. The method of claim 26, wherein the counter comprises a staling counter and wherein incrementing the counter comprises generating a staling notification.

28. The method of claim 26, further comprising:
determining a number of stripes of the first frame corresponding to the value of the greatest motion vector; and
adding an integer value to the number of stripes to determine the threshold value.

29. The method of claim 28, wherein the integer value is three.

30. The method of claim 24, wherein determining a greatest motion vector associated with the first frame and the second frame comprises determining a greatest motion vector of a plurality of motion vectors associated with the first frame and the second frame determined by a plurality of cores of the image processor.
